(19) United States
(12) Patent Application Publication
(10) Pub. No.: US 2026/0147886 A1
(43) Pub. Date: May 28, 2026

(54) MONITORING DEVICE AND MONITORING METHOD

(71) Applicant: Panasonic Automotive Systems Co., Ltd., Kanagawa (JP)

(72) Inventors: Akihito TAKEUCHI, Osaka (JP); Takumaru NAGAI, Osaka (JP); Tomohisa SEZAKI, Kanagawa (JP)

(73) Assignee: Panasonic Automotive Systems Co., Ltd., Kanagawa (JP)

(21) Appl. No.: 19/366,025

(22) Filed: Oct. 22, 2025

(30) Foreign Application Priority Data
Nov. 25, 2024 (JP) 2024-204702

(51) Int. Cl. G06F 21/55

(52) U.S. Cl. CPC G06F 21/554; G06F 2221/034

(57) ABSTRACT

A monitoring device includes: an attack detector that detects an attack against at least one of: a mobile body that includes an electric motor as a driving source; or charge-discharge equipment that performs at least one of charging or discharging on the mobile body, the at least one of charging or discharging involving communication with the mobile body; a countermeasure determiner that determines whether to change a communication status between the mobile body and the charge-discharge equipment, based on a risk level of the attack detected, the risk level being determined based on details of the attack detected; and a communication controller that changes the communication status between the mobile body and the charge-discharge equipment when the communication status between the mobile body and the charge-discharge equipment is determined to be changed.

### CROSS REFERENCE TO RELATED APPLICATION

The present application is based on and claims priority of Japanese Patent Application No. 2024-204702 filed on Nov. 25, 2024.

### FIELD

The present disclosure relates to a monitoring device and a monitoring method.

### BACKGROUND

Devices that control the charge or discharge amount in response to detecting a cyberattack (hereafter, also referred to simply as an attack) have been developed (see Patent Literature (PTL) 1, for example).

PTL 1 discloses an electronic control device that, in the event of an attack such as unauthorized access that tampers with data during autonomous driving control, reduces at least one of the preset battery charge limit or the preset battery discharge limit compared to that in a normal control state in the absence of an attack.

### CITATION LIST

### Patent Literature

PTL 1: Japanese Unexamined Patent Application Publication No. 2019-93808

### SUMMARY

However, the electronic control device according to PTL 1 can be improved upon.

In view of this, the present disclosure provides a monitoring device and so forth that is capable of improving upon the above related art.

In accordance with an aspect of the present disclosure, a monitoring device includes: an attack detection circuit that detects an attack against at least one of: a mobile body that includes an electric motor as a driving source; or charge-discharge equipment that performs at least one of charging or discharging on the mobile body, the at least one of charging or discharging involving communication with the mobile body; a countermeasure determination circuit that determines whether to change a communication status between the mobile body and the charge-discharge equipment, based on a risk level of the attack detected, the risk level being determined based on details of the attack detected; and a communication control circuit that changes the communication status between the mobile body and the charge-discharge equipment when the communication status between the mobile body and the charge-discharge equipment is determined to be changed.

In accordance with another aspect of the present disclosure, a monitoring method includes: detecting an attack against at least one of: a mobile body that includes an electric motor as a driving source; or charge-discharge equipment that performs at least one of charging or discharging on the mobile body, the at least one of charging or discharging involving communication with the mobile body; determining whether to change a communication status between the mobile body and the charge-discharge equipment, based on a risk level of the attack detected, the risk level being determined based on details of the attack detected; and changing the communication status between the mobile body and the charge-discharge equipment when the communication status between the mobile body and the charge-discharge equipment is determined to be changed.

The present disclosure can provide a monitoring device and so forth that are capable of further improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram illustrating the configuration of a charge-discharge system according to Embodiment 1.

FIG. 2 is a diagram illustrating a first example of a risk table.

FIG. 3 is a diagram illustrating a second example of the risk table.

FIG. 4 is a flowchart illustrating processes performed by a vehicle according to Embodiment 1.

FIG. 5 is a block diagram illustrating the configuration of a charge-discharge system according to Embodiment 2.

FIG. 6 is a diagram illustrating a first example of a countermeasure table.

FIG. 7 is a flowchart illustrating processes performed by a vehicle according to Embodiment 2.

FIG. 8 is a diagram illustrating a third example of the risk table.

FIG. 9 is a diagram illustrating a fourth example of the risk table.

FIG. 10 is a diagram illustrating a second example of the countermeasure table.

FIG. 11 is a flowchart illustrating a monitoring method according to one aspect of the present disclosure.

### DESCRIPTION OF EMBODIMENTS

### Underlying Knowledge Forming Basis of the Present Disclosure

A battery electric vehicle (BEV) communicates with an infrastructure such as a charge stand or a smart grid to perform charging control or billing control. One use case is that power stored in the battery of the BEV is discharged to a smart grid via a discharge stand.

Examples of threats specific to BEVs include a risk that the BEV may be taken over by an attacker through an attack and overcharged due to excessive power supply. Such a risk can be extremely dangerous, possibly igniting a fire.

Moreover, another example of a risk is that the communication between the BEV and the charge-discharge stand taken over by malware may cause personal information leakage and malware infection of the BEV. For example, communication connection between the BEV taken over by an attacker and an infrastructure may allow the threat to extend from the BEV to the infrastructure. More specifically, the BEV may be at risk of being exploited as a stepping stone.

Here, to charge or discharge the BEV, communication between the BEV and the charge-discharge stand (such as electric vehicle supply equipment (EVSE)) is necessary. Thus, communication block (termination) without question in the event of an attack against the BEV, that is, in the event of occurrence of an anomaly, disables the BEV from being charged or discharged.

Although various types of attacks are possible, not every attack on the BEV immediately pose a high risk of danger, such as overcharging. On this account, immediate termination of communication at the initial stage of the attack may be inefficient for the charging and discharging of the BEV.

In response to the above issue, the inventors have come up with the present disclosure.

Hereinafter, certain exemplary embodiments will be described in detail with reference to the accompanying Drawings.

The following embodiments are specific examples of the present disclosure. The numerical values, shapes, materials, elements, arrangement and connection configuration of the elements, steps, the order of the steps, etc., described in the following embodiments are merely examples, and are not intended to limit the present disclosure. Among elements in the following embodiments, those not described in any one of the independent claims indicating the broadest concept of the present disclosure are described as optional elements. Note that the respective figures are schematic diagrams and are not necessarily precise illustrations. Additionally, components that are essentially the same share like reference signs in the figures. Accordingly, overlapping explanations thereof are omitted or simplified.

Furthermore, in the present specification, expressions like “more than the threshold value” and “less than or equal to the threshold value” are used simply to distinguish values with respect to the threshold value that is serves as the boundary. Thus, “more than the threshold value” can mean “more than or equal to the threshold value” and “less than or equal to the threshold value” can mean “less than the threshold value”.

In the present embodiments, a numeric value, such as a threshold value, is merely an example and may be replaced with any other numeric value.

### Embodiment 1

### [Configuration]

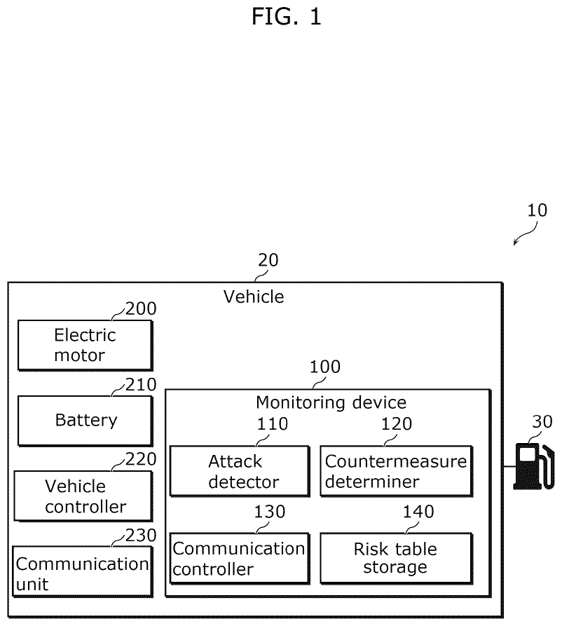

FIG. 1 is a block diagram illustrating the configuration of charge-discharge system 10 according to Embodiment 1.

In charge-discharge system 10, charging and discharging are performed between vehicle 20 and charge-discharge stand 30. For example, charge-discharge stand 30 is placed in a station (a charge-discharge station) where charging and discharging are performed. Charge-discharge stand 30 charges (supplies power to) vehicle 20 and receives discharge from vehicle 20.

Note that when charge-discharge stand 30 performs at least one of charging vehicle 20 or receiving discharge from vehicle 20, this is also described simply as that charge-discharge stand 30 performs charging/discharging on vehicle 20.

Charge-discharge system 10 includes vehicle 20 and charge-discharge stand 30.

Vehicle 20 is an automobile that uses electricity and is, for example, an electric vehicle (EV). For example, vehicle 20 runs using battery 210 and electric motor 200 that is a driving source driven by power from battery 210.

Note that vehicle 20 may be a mobile body that uses electricity, such as a motorcycle or a mobile robot. Vehicle 20 is an example of the mobile body.

Charge-discharge stand 30 is an EV charger-discharger that communicates with vehicle 20 to charge vehicle 20 (or more specifically, charge battery 210 of vehicle 20) and to receive discharge from vehicle 20 (or more specifically, from battery 210). Charge-discharge stand 30 performs charging/discharging on vehicle 20 while communicating with vehicle 20. In other words, charging/discharging is performed between vehicle 20 and charge-discharge stand 30 and involves communication with vehicle 20. For example, charge-discharge stand 30 supplies power from an external commercial power supply, which is not shown, to vehicle 20 or supplies power from vehicle 20 to the external commercial power supply. The external commercial power supply is owned by an electric power utility company, for example. With this, electricity trading, such as power selling or power purchasing, is performed between an owner (user) of vehicle 20 and a management company that manages charge-discharge stand 30.

Note that although charge-discharge stand 30 has both the charging function and the discharging function, charge-discharge stand 30 may have either the charging function or the discharging function, for example. Thus, charge-discharge stand 30 does not need to have the charging function or does not need to have the discharging function.

Charge-discharge stand 30 is placed at a station, for example. Moreover, charge-discharge stand 30 may be placed at a home, for example.

For example, when charging/discharging is performed between vehicle 20 and charge-discharge stand 30, charge/discharge information indicating a result of the charging/discharging performed by charge-discharge stand 30 (for example, information indicating the charge amount or the discharge amount) is transmitted to a station server that manages the station. In this case, the charge/discharge information on vehicle 20 is transmitted to a vehicle management server that manages vehicle 20 and/or to a terminal such as a personal computer (PC) used by the user of vehicle 20. For example, each of the vehicle management server and the station server is implemented by a computer that includes a communication interface, a nonvolatile memory storing programs, a volatile memory as a temporary storage area used for executing the programs, an input-output port for transmitting and receiving signals, and a processor for executing the programs.

Vehicle 20 includes monitoring device 100, electric motor 200, battery 210, vehicle controller 220, and communication unit 230. Although not shown, vehicle 20 includes: a port that is connected to a power line used for charging/discharging performed between vehicle 20 and charge-discharge stand 30; and features included in a typical electric vehicle.

Monitoring device 100 is a computer that monitors at least one of vehicle 20 or charge-discharge stand 30. More specifically, monitoring device 100 detects an attack against at least one of vehicle 20 or charge-discharge stand 30 while vehicle 20 and charge-discharge stand 30 are communicating with each other to perform charging/discharging. In other words, monitoring device 100 determines whether at least one of vehicle 20 or charge-discharge stand 30 has received an attack. When monitoring device 100 has detected the attack, that is, when at least one of vehicle 20 or charge-discharge stand 30 is determined to have received the attack, monitoring device 100 executes a process of changing a communication status between vehicle 20 and charge-discharge stand 30, based on the risk level of the detected attack.

Monitoring device 100 includes attack detector 110, countermeasure determiner 120, communication controller 130, and risk table storage 140.

Attack detector 110 is a processor that detects an attack against at least one of vehicle 20 or charge-discharge stand 30 that performs charging/discharging (charging or discharging) on vehicle 20 which involves communication with vehicle 20. More specifically, attack detector 110 performs a detection process of detecting an attack against at least one of vehicle 20 or charge-discharge stand 30 while vehicle 20 and charge-discharge stand 30 are communicating with each other and performing charging/discharging. Attack detector 110 detects an attack against vehicle 20 or charge-discharge stand 30, based on data inputted to or outputted from an electronic control unit (ECU) of vehicle 20, data transmitted or received via communication unit 230, and data transmitted or received by charge-discharge stand 30, for example.

Furthermore, attack detector 110 determines details of the detected attack, for example. The details of the attack include an attack type, an attack source (attacker), and an attacked entity (attack target), for example. Attack detector 110 detects the details of the attack, based on data inputted to or outputted from an ECU of vehicle 20, data transmitted or received via communication unit 230, and data transmitted or received by charge-discharge stand 30, for example.

Note that the methods used by attack detector 110 to detect an attack and determine the details of the attack are not intended to be particularly limiting. For example, attack detector 110 may be implemented by an intrusion detection system (IDS). Alternatively, monitoring device 100 may store in advance rule information indicating rules for detecting an attack and determining the details of the attack. In this case, attack detector 110 may detect an attack and determine the details of the attack, based on the rule information.

Countermeasure determiner 120 is a processor that determines, based on the risk level of the detected attack, whether to change the communication status between vehicle 20 and charge-discharge stand 30. The risk level is determined based on the details of the attack detected by attack detector 110. More specifically, countermeasure determiner 120 determines, based on the risk level, whether to continue or terminate the communication between vehicle 20 and charge-discharge stand 30.

For example, countermeasure determiner 120 identifies a type of the attack detected by attack detector 110 and determines (calculates), based on the type of the detected attack, the risk level of the detected attack. The type of the attack is an example of the details of the attack. Furthermore, for example, countermeasure determiner 120 identifies an attacked entity that has received the attack detected by attack detector 110 and determines, based on the attacked entity, the risk level of the detected attack. The attacked entity is another example of the details of the attack. Furthermore, for example, countermeasure determiner 120 identifies an attack source of the detected attack and determines, based on the attacked entity and the attack source, the risk level of the detected attack. The attack source is another example of the details of the attack.

Countermeasure determiner 120 determines the risk level of the detected attack, based on a risk table, for example.

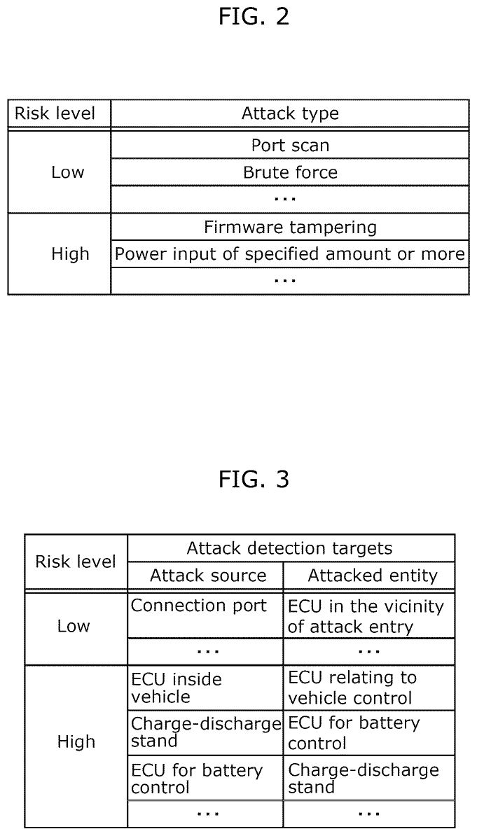

FIG. 2 and FIG. 3 are diagrams illustrating specific examples of the risk table.

FIG. 2 illustrates a first example of the risk table that shows a correspondence relationship between attack types and risk levels. More specifically, the risk table illustrated in the present example presents information associating each attack type with a corresponding risk level.

In the present example, attack types include “port scan”, “brute force”, “firmware tampering”, and “power input of specified amount or more”. The specified amount of power to be inputted to battery 210 may be freely defined in advance and is not intended to be particularly limiting.

In the present example, the risk level is categorized as “low” or “high”. For example, the risk levels of “port scan” and “brute force” are categorized as “low”. Furthermore, in the present example, the risk levels of “firmware tampering” and “power input of specified amount or more” are categorized as “high”.

For example, when the type of the attack detected by attack detector 110 is “port scan”, countermeasure determiner 120 determines the risk level of the detected attack to be “low”.

FIG. 3 illustrates a second example of the risk table that shows a correspondence relationship between attack detection targets and risk levels. More specifically, the risk table illustrated in the present example presents information associating each attack detection target with a corresponding risk level.

An attack detection target is a target to be detected as an attack source or an attacked entity by attack detector 110. For example, attack detector 110 detects the attack by analyzing data inputted to and outputted from the attack detection target.

In the present example, the attack detection targets include “connection port”, “ECU inside vehicle”, “charge-discharge stand”, “ECU for battery control”, “ECU in the vicinity of attack entry”, and “ECU relating to vehicle control”. Vehicle 20 includes a plurality of ECUs. For example, the plurality of ECUs may be connected, in a daisy chain configuration, with communication unit 230 that communicates with an external communication device. For example, “ECU in the vicinity of attack entry” is an ECU disposed at a first or second stage as viewed from communication unit 230 and thus located relatively proximate to communication unit 230. In contrast, for example, “ECU inside vehicle” is an ECU disposed at a third or fourth stage as viewed from communication unit 230 and thus located relatively away from communication unit 230. For example, “connection port” is a wireless communication circuit included in communication unit 230. For example, “ECU for battery control” is an ECU that controls battery 210 included in vehicle 20. For example, “ECU relating to vehicle control” is an ECU that controls running of vehicle 20 by controlling, for example, the engine included in vehicle 20. Note that each of the aforementioned ECUs may have a physical enclosure. Alternatively, a plurality of ECUs may be included in a single enclosure using a virtualization technology, such as a hypervisor.

In the present example, the risk levels illustrated in the risk table are set according to the attack detection targets including the attack source and the attacked entity. Note that the attack source referred to here is a device such as a processor that is attacked by, for example, an external third party and then unintentionally transmits data to a device included in vehicle 20 or in charge-discharge stand 30. Such data transmission interferes with an operation performed by this device of vehicle 20 or charge-discharge stand 30 or causes this device to execute an unintentional operation (that is, such data transmission allows this processor to make an attack on this device).

In the present example, when the attack source is “connection port” and the attacked entity is “ECU in the vicinity of attack entry”, the risk level is categorized as “low”. In the present example, when the attack source is “ECU inside vehicle”, “charge-discharge stand”, or “ECU for battery control” and the attacked entity is “ECU relating to vehicle control”, “ECU for battery control” or “charge-discharge stand”, the risk level is categorized as “high”.

For example, when the type of the attack detected by attack detector 110 is “port scan”, countermeasure determiner 120 determines the risk level of the detected attack to be “low”. For example, when the attacked entity that is the target of the attack detected by attack detector 110 is “ECU for battery control” and the attack source of this attack is “ECU inside vehicle”, countermeasure determiner 120 determines the risk level of the detected attack to be “high”.

In this way, countermeasure determiner 120 determines the risk level of the detected attack, based on risk table information (also referred to simply as the risk table) that indicates the correspondence relationship between attack details and risk levels, for example.

Note that countermeasure determiner 120 may determine the risk level, based on both the risk table in the first example and the risk table in the second example. In this case, for example, when the risk level of the attack is “high” based on only one of the risk tables, countermeasure determiner 120 determines the risk level of this attack to be “high”. Moreover, when the risk level of the attack is “low” based on both of the risk tables, countermeasure determiner 120 determines the risk level of this attack to be “low”.

The attack types, the attack detection targets, and the risk levels associated with the attack types and the attack detection targets may be freely defined in advance, and are not intended to be particularly limiting.

Moreover, the risk table may include only the attack sources or only the attacked entities as the attack detection targets, among the attack sources and the attacked entities.

Furthermore, attack detector 110 may detect an attack against at least one of vehicle 20 or charge-discharge stand 30, based on attack information received from an external device about the attack against the at least one. The attack information indicates details of the attack, for example. Countermeasure determiner 120 determines the risk level of the detected attack, based on the details of the attack indicated by the attack information, for example. Furthermore, countermeasure determiner 120 may obtain, from the external device, risk level information indicating the risk level of the detected attack. In this way, the attack detection (or more specifically, the determination of the attack details) and/or the determination of the risk level may be performed by the external device that is, for example, a computer such as an IDS that has the function of detecting attacks. Monitoring device 100 may obtain information indicating the result of the detection performed by the external device and/or the result of the determination performed by the external device. Then, based on the obtained information, monitoring device 100 may detect the attack and/or determine the details of the attack.

Furthermore, countermeasure determiner 120 determines, based on the risk level determined as described above, whether to continue or terminate the communication between vehicle 20 and charge-discharge stand 30, for example. For example, when the risk level is “low”, countermeasure determiner 120 determines to continue the communication between vehicle 20 and charge-discharge stand 30. In contrast, for example, when the risk level is “high”, countermeasure determiner 120 determines to terminate the communication between vehicle 20 and charge-discharge stand 30. Countermeasure determiner 120 outputs an instruction (instruction information) corresponding to the risk level to communication controller 130. For example, when countermeasure determiner 120 determines to terminate the communication between vehicle 20 and charge-discharge stand 30, countermeasure determiner 120 outputs, to communication controller 130, an instruction to terminate the communication between vehicle 20 and charge-discharge stand 30.

Communication controller 130 is a processor that controls the communication status between vehicle 20 and charge-discharge stand 30. To be more specific, when countermeasure determiner 120 determines to change the communication status between vehicle 20 and charge-discharge stand 30, communication controller 130 terminates the communication established via communication unit 230 between vehicle controller 220 and charge-discharge stand 30. For example, when communication controller 130 has received the instruction to terminate the communication between vehicle 20 and charge-discharge stand 30, communication controller 130 terminates the communication between vehicle controller 220 and charge-discharge stand 30 by transferring this instruction to vehicle controller 220. Communication controller 130 may terminate the communication between vehicle controller 220 and charge-discharge stand 30 by controlling communication unit 230. In this way, communication controller 130 communicates with charge-discharge stand 30, controls the start and end of charging/discharging, and controls the charge/discharge amount of battery 210.

Furthermore, for example, communication controller 130 controls the communication established via communication unit 230 between vehicle 20 and an external device or an external communication device, such as a terminal. For example, when the communication between vehicle 20 and charge-discharge stand 30 is determined to be terminated based on the risk level of the detected attack, countermeasure determiner 120 outputs notification information indicating that the communication between vehicle 20 and charge-discharge stand 30 is to be terminated. The notification information is transmitted via communication unit 230 to, for example, a terminal used by the user of vehicle 20. With this, an image or voice outputted by the terminal based on the notification information notifies the user of the details indicated by the notification information, for example.

The notification information is transmitted to the terminal of the user of the mobile body, for example.

Risk table storage 140 is a storage device that stores the risk tables.

Electric motor 200 is a device such as a motor that is driven by power from battery 210.

Battery 210 supplies power to electric motor 200, stores power supplied from charge-discharge stand 30, and discharges power to charge-discharge stand 30.

Vehicle controller 220 is a processor that controls operations of vehicle 20. For example, vehicle controller 220 controls communications with charge-discharge stand 30 and an external communication device via communication unit 230. Moreover, vehicle controller 220 controls running of vehicle 20 by controlling electric motor 200 included in vehicle 20. Moreover, vehicle controller 220 controls charging/discharging performed between vehicle 20 and charge-discharge stand 30 by controlling battery 210 of vehicle 20 and the port connected to battery 210.

Communication unit 230 is a communication interface for communicating with charge-discharge stand 30 and an external communication device. By controlling communication unit 230, vehicle controller 220 controls the communications between vehicle 20 and each of charge-discharge stand 30 and the external communication device individually.

Monitoring device 100 communicates with the external communication device via communication unit 230 of vehicle 20, for example. However, monitoring device 100 may include a communication interface different from communication unit 230, and then communicate with the external communication device via this communication interface.

Furthermore, by controlling communication unit 230, communication controller 130 may control the communications between monitoring device 100 and either charge-discharge stand 30 or the external communication device or both.

Furthermore, when attack detector 110 has detected an attack, communication controller 130 may transmit, via communication unit 230, alert information including information on the details of the detected attack to at least one of the user of vehicle 20 or the user of charge-discharge stand 30 and/or to a computer used in a security operation center (SOC).

The processors such as attack detector 110, countermeasure determiner 120, communication controller 130, and vehicle controller 220 are implemented by one or more processors, such as ECUs or central processing units (CPUs), and one or more memories storing control programs to be executed by the one or more processors.

Risk table storage 140 is implemented by one or more storage devices, such as hard disk drives (HDDs) or semiconductor memories.

Each of the aforementioned communication interfaces including communication unit 230 is implemented by: an antenna and a wireless communication circuit for enabling wireless communication; and/or a connector that is connected to a communication line, for example. The communications between the devices including vehicle 20 and charge-discharge stand 30 may be established using power line communication (PLC), for example. Each of these devices may include a component, such as a circuit, to enable PLC, as a communication interface. Communication standards for the communication interface may be freely defined and is not intended to be particularly limiting.

### [Processes]

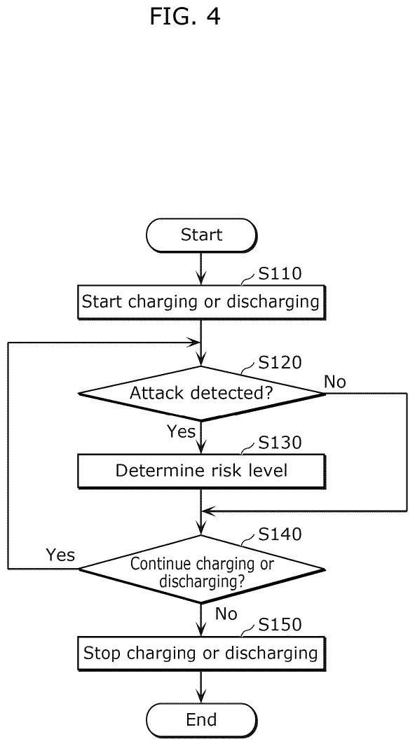

FIG. 4 is a flowchart illustrating processes performed by vehicle 20 according to Embodiment 1.

First, vehicle 20 starts communication with charge-discharge stand 30 and starts charging or discharging (S110). For example, when the power line is connected to the port, vehicle controller 220 starts communication with charge-discharge stand 30. Then, vehicle controller 220 outputs, to monitoring device 100, start information indicating that charging/discharging of vehicle 20 has started. For example, when monitoring device 100 has obtained the start information, monitoring device 100 determines that charging/discharging of vehicle 20 has started.

Note that monitoring device 100 may obtain information indicating the amount of power detected by, for example, a power meter that detects power received and/or supplied via the port of vehicle 20. Then, monitoring device 100 may determine, based on the detection result indicated by the obtained information, whether charging/discharging of vehicle 20 has started.

Next, monitoring device 100 determines whether an attack against at least one of vehicle 20 or charge-discharge stand 30 has been detected (S120). For example, when charging/discharging of vehicle 20 has started, monitoring device 100 starts the detection process of detecting an attack against at least one of vehicle 20 or charge-discharge stand 30. For example, monitoring device 100 continues performing the detection process during the charging/discharging of vehicle 20.

Note that monitoring device 100 may continue performing the detection process while vehicle 20 and charge-discharge stand 30 are communicating with each other or may continue performing the detection process while the engine of vehicle 20 is on.

When the attack is determined to be detected (Yes in S120), monitoring device 100 determines the risk level of the detected attack, based on the risk table (S130).

Next, monitoring device 100 determines whether to continue the charging/discharging of vehicle 20 (S140). For example, when step S140 is performed after step S130, monitoring device 100 determines, based on the risk level of the detected attack, whether to continue the charging/discharging of vehicle 20. For example, monitoring device 100 determines whether to continue the charging/discharging of vehicle 20, based on the amount of power of battery 210, the amount of power supplied to battery 210, or the amount of power discharged from battery 210. To be more specific, monitoring device 100 determines, based on the risk level, whether to continue the charging/discharging of vehicle 20 and also determines whether vehicle 20 has been charged/discharged by a predetermined amount of power (or more specifically, by a planned amount of power). In contrast, for example, when no attack is determined to be detected (No in S120), monitoring device 100 determines whether vehicle 20 has been charged/discharged by the predetermined amount of power (or more specifically, by the planned amount of power), without determining whether to continue the charging/discharging of vehicle 20 based on the risk level in step S140.

The predetermined amount of power may be freely set and is not intended to be particularly limiting. For example, the predetermined amount of power is set by the user of vehicle 20. The predetermined amount of power is, for example, the amount of power that causes battery 210 to be fully charged or the amount of power that causes the remaining power of battery 210 to become zero. For example, when vehicle 20 is being charged, monitoring device 100 determines whether battery 210 is fully charged. For example, when vehicle 20 is discharging, monitoring device 100 determines whether the remaining power of battery 210 is zero. For example, when vehicle 20 is being charged and monitoring device 100 determines that battery 210 is not fully charged, monitoring device 100 proceeds to “Yes” in step S140. In contrast, when vehicle 20 is being charged and monitoring device 100 determines that battery 210 is fully charged, monitoring device 100 proceeds to “No” in step S140. For example, when vehicle 20 is discharging and monitoring device 100 determines that the remaining power of battery 210 is not zero, monitoring device 100 proceeds to “Yes” in step S140. In contrast, when vehicle 20 is discharging and monitoring device 100 determines that the remaining power of battery 210 is zero, monitoring device 100 proceeds to “No” in step S140.

When monitoring device 100 determines to continue the charging/discharging of vehicle 20 (Yes in S140), monitoring device 100 returns to step S120 and continues performing the detection process.

In contrast, when monitoring device 100 determines not to continue the charging/discharging of vehicle 20 (No in S140), monitoring device 100 causes the charging/discharging of vehicle 20 to end (S150). For example, by outputting, to communication controller 130, an instruction to terminate the communication between vehicle 20 and charge-discharge stand 30, monitoring device 100 terminates the communication between vehicle controller 220 and charge-discharge stand 30 and thus causes the charging/discharging of vehicle 20 to stop.

Note that vehicle controller 220 may determine whether to continue the charging/discharging of vehicle 20, based on the amount of power of battery 210, the amount of power supplied to battery 210, or the amount of power discharged from battery 210. Then, based on a result of this determination, vehicle controller 220 may continue or stop the charging/discharging of vehicle 20. To be more specific, vehicle controller 220 may determine whether vehicle 20 has been charged/discharged by the predetermined amount of power in the absence of any attacks. In this case, for example, monitoring device 100 need not determine in step S140 whether vehicle 20 has been charged/discharged by the predetermined amount of power.

### [Advantageous Effects Etc.]

As described thus far, when monitoring device 100 has detected an attack (a cyberattack) against vehicle 20 or charge-discharge stand 30, monitoring device 100 determines, based on the risk level (risk value) of the attack, whether to allow the communication with charge-discharge stand 30. For example, when the risk level is low, monitoring device 100 causes the communication between vehicle 20 and charge-discharge stand 30 to continue. When the risk level is high, monitoring device 100 blocks the communication (stops the charging or the discharging) between vehicle 20 and charge-discharge stand 30.

For example, the risk level of an attack having a small impact on vehicle 20 (such as an attack that does not immediately threaten human life) is categorized as low. In contrast, for example, the risk level of an attack having a large impact on vehicle 20 (such as an attack that can immediately threaten human life) is categorized as high.

The risk level is determined (calculated) based on at least one of the attack type or the attack detection target, for example.

An attack type with a low risk level indicates that the attack has a small impact on vehicle 20. Examples of such an attack include: a reconnaissance attack, such as port scan; and an attack, such as a brute force attack, that circumvents authentication. In contrast, an attack type with a high risk level indicates that the attack has a large impact on vehicle 20. Examples of such an attack include: firmware tampering; and power input of the specified amount or more.

A detection-target attack with a low risk level is performed by an attack source against an attacked entity. Specifically, examples of such an attack include: an attack from an external communication device of vehicle 20 to a wireless-communication connection port (such as communication unit 230) included in vehicle 20 for communication with this external communication device; and an attack from this connection port to an ECU in the vicinity of this connection port (such as the aforementioned “ECU in the vicinity of attack entry”).

A detection-target attack with a high risk level is performed by an attack source against an attacked entity. Specifically, examples of such an attack include: an attack from an ECU away from the connection port (such as the aforementioned “ECU inside vehicle”) to a component directly relating to the control over vehicle 20 (such as the aforementioned “ECU relating to vehicle control”); an attack from charge-discharge stand 30 to an ECU that controls battery 210; and an attack from the ECU that controls battery 210 to charge-discharge stand 30.

Monitoring device 100 described above is capable of reducing unnecessary termination of communication even when an attack against vehicle 20 or charge-discharge stand 30 is detected. More specifically, in the event of an attack with a low risk level, charging/discharging is permitted. However, in the event of an attack with a high risk level, the communication is blocked to prevent the attack from spreading. Thus, charging/discharging of vehicle 20 can be controlled efficiently.

### Embodiment 2

Next, a monitoring device is described according to Embodiment 2. Note that Embodiment 2 mainly describes differences from Embodiment 1. Note also that components and processes in Embodiment 2 that are substantially identical to those described in Embodiment 1 are assigned the same reference marks as in Embodiment 1 and, therefore, descriptions of such components and processes may be omitted or simplified.

### [Configuration]

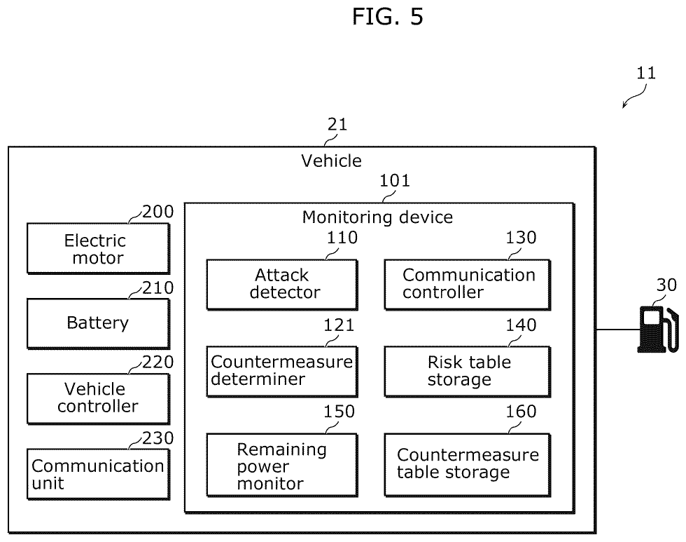

FIG. 5 is a block diagram illustrating the configuration of charge-discharge system 11 according to Embodiment 2.

In charge-discharge system 11, charging and discharging are performed between vehicle 21 and charge-discharge stand 30.

Charge-discharge system 11 includes vehicle 21 and charge-discharge stand 30.

Vehicle 21 is an automobile that uses electricity and is, for example, an electric vehicle (EV). More specifically, vehicle 21 includes battery 210 and electric motor 200 that is a driving source driven by power from battery 210.

Note that vehicle 21 may be a mobile body that uses electricity, such as a motorcycle or a mobile robot. Vehicle 21 is an example of the mobile body.

Vehicle 21 includes monitoring device 101, electric motor 200, battery 210, vehicle controller 220, and communication unit 230. Although not shown, vehicle 21 includes: a port that is connected to a power line used for charging/discharging performed between vehicle 21 and charge-discharge stand 30; and features included in a typical electric vehicle.

Monitoring device 101 is a computer that monitors at least one of vehicle 21 or charge-discharge stand 30.

Monitoring device 101 includes attack detector 110, countermeasure determiner 121, communication controller 130, risk table storage 140, remaining power monitor 150, and countermeasure table storage 160.

Countermeasure determiner 121 is a processor that determines, based on the risk level of the detected attack, whether to change the communication status between vehicle 21 and charge-discharge stand 30. The risk level is determined based on the details of the attack detected by attack detector 110. More specifically, countermeasure determiner 121 determines, based on the risk level, whether to continue or terminate the communication between vehicle 21 and charge-discharge stand 30.

For example, countermeasure determiner 121 identifies a type of the attack detected by attack detector 110 and determines, based on the type of the detected attack, the risk level of the detected attack. Furthermore, for example, countermeasure determiner 121 identifies an attacked entity that has received the attack detected by attack detector 110 and determines, based on the attacked entity, the risk level of the detected attack. Furthermore, for example, countermeasure determiner 121 identifies an attack source of the detected attack and determines, based on the attacked entity and the attack source, the risk level of the detected attack. Countermeasure determiner 121 determines the risk level of the detected attack, based on the aforementioned risk table, for example. As with countermeasure determiner 120, countermeasure determiner 121 may obtain, from an external device, risk level information indicating the risk level of the detected attack.

Furthermore, countermeasure determiner 121 determines whether to change the communication status between vehicle 21 and charge-discharge stand 30, based on the remaining power of battery 210 of vehicle 21 that is monitored (detected) by remaining power monitor 150 and the risk level of the attack detected by attack detector 110.

Remaining power monitor 150 is a processor that monitors the remaining power of battery 210 included in vehicle 21. For example, remaining power monitor 150 monitors the remaining power of battery 210, by obtaining information indicating the amount of power relating to battery 210 that is detected by a power sensor (not shown). The power sensor detects the amount of power stored (the current remaining power) in battery 210 and/or the amount of power inputted to and outputted from battery 210. Remaining power monitor 150 outputs, to countermeasure determiner 121, remaining power information about the remaining power of battery 210, for example.

The remaining power information indicates a percentage charged relative to the maximum capacity of battery 210. The remaining power information may be information about the remaining power of battery 210. Thus, the remaining power information may directly indicate the amount of power currently stored in battery 210, for example.

Countermeasure determiner 121 determines whether to change the communication status between vehicle 21 and charge-discharge stand 30, based on the risk level of the attack detected by attack detector 110, the remaining power indicated by the remaining power information, and countermeasure table information (also referred to simply as the countermeasure table).

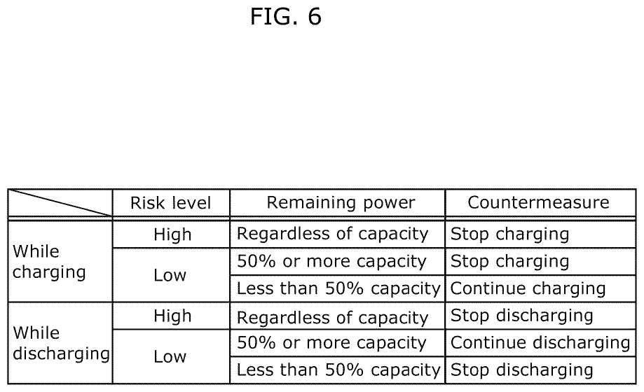

FIG. 6 is a diagram illustrating a specific example of the countermeasure table.

FIG. 6 illustrates a first example of the countermeasure table showing a correspondence relationship among risk levels, remaining power, and countermeasure methods (indicated as “countermeasure” in FIG. 6). Information on the countermeasure method included in the countermeasure table indicates a process to be performed by monitoring device 101.

In the present example, when the risk level of the detected attack is determined to be “high” while vehicle 21 is being charged (indicated as “while charging” in FIG. 6), countermeasure determiner 121 performs a process of stopping the charging of vehicle 21 (indicated as “stop charging” in FIG. 6) regardless of the remaining power of battery 210 (indicated as “regardless of capacity” in FIG. 6).

In the present example, when the risk level of the detected attack is determined to be “low” and the remaining power of battery 210 is 50% or more of the maximum capacity of battery 210 (indicated as “50% or more capacity” in FIG. 6) while vehicle 21 is being charged, countermeasure determiner 121 performs the process of stopping the charging of vehicle 21.

In contrast, in the present example, when the risk level of the detected attack is determined to be “low” and the remaining power of battery 210 is less than 50% of the maximum capacity of battery 210 (indicated as “less than 50% capacity” in FIG. 6) while vehicle 21 is being charged, countermeasure determiner 121 causes the charging of vehicle 21 to continue (indicated as “continue charging” in FIG. 6). More specifically, in this case, countermeasure determiner 121 does not perform the process of stopping the charging of vehicle 21. Thus, vehicle 21 continues being charged and attack detector 110 continues performing the detection process of detecting an attack, for example.

In the present example, when the risk level of the detected attack is determined to be “high” while vehicle 21 is discharging (indicated as “while discharging” in FIG. 6), countermeasure determiner 121 performs a process of stopping the discharging of vehicle 21 (indicated as “stop discharging” in FIG. 6) regardless of the remaining power of battery 210.

In the present example, when the risk level of the detected attack is determined to be “low” and the remaining power of battery 210 is 50% or more of the maximum capacity of battery 210 while vehicle 21 is discharging, countermeasure determiner 121 causes the discharging of vehicle 21 to continue (indicated as “continue discharging” in FIG. 6).

In contrast, in the present example, when the risk level of the detected attack is determined to be “low” and the remaining power of battery 210 is less than 50% of the maximum capacity of battery 210 while vehicle 21 is discharging, countermeasure determiner 121 performs the process of stopping the discharging of vehicle 21.

In the present example as described, when the risk level of the detected attack is “low”, whether to continue the charging/discharging is determined based on the remaining power of battery 210.

Note that a specific value of the remaining power used in the determination may be freely defined.

Furthermore, information indicating the maximum capacity of battery 210 may be stored beforehand in a storage device, such as an HDD or a semiconductor memory, that is included in monitoring device 101.

Countermeasure table storage 160 is a storage device that stores the countermeasure table.

The processors such as attack detector 110, countermeasure determiner 121, communication controller 130, remaining power monitor 150, and vehicle controller 220 are implemented by one or more processors, such as ECUs or CPUs, and one or more memories storing control programs to be executed by the one or more processors.

Risk table storage 140 and countermeasure table storage 160 are implemented by one or more storage devices, such as HDDs or semiconductor memories.

### [Processes]

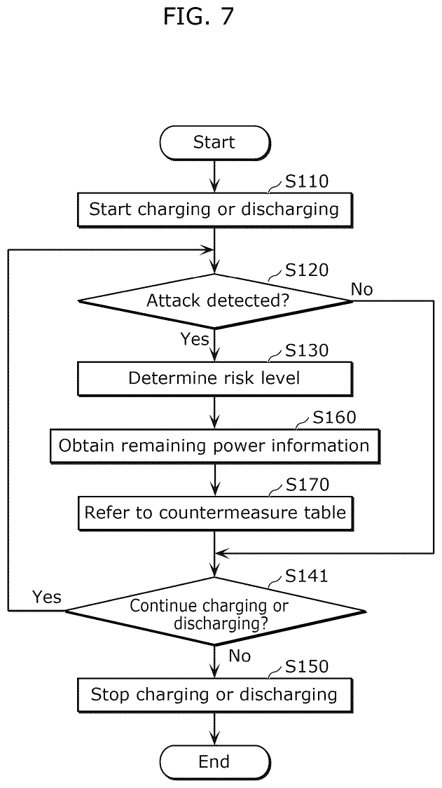

FIG. 7 is a flowchart illustrating processes performed by vehicle 21 according to Embodiment 2.

First, vehicle 21 starts communication with charge-discharge stand 30 and starts charging or discharging (S110). For example, when the power line is connected to the port, vehicle controller 220 starts communication with charge-discharge stand 30. Then, vehicle controller 220 outputs, to monitoring device 101, start information indicating that charging/discharging of vehicle 21 has started. For example, when monitoring device 101 has obtained the start information, monitoring device 101 determines that charging/discharging of vehicle 21 has started.

Next, monitoring device 101 determines whether an attack against at least one of vehicle 21 or charge-discharge stand 30 has been detected (S120).

When the attack is determined to be detected (Yes in S120), monitoring device 101 determines the risk level of the detected attack, based on the risk table (S130).

Next, monitoring device 101 obtains the remaining power information indicating the remaining power of battery 210 (S160). More specifically, countermeasure determiner 121 obtains the remaining power information indicating the remaining power of battery 210 from remaining power monitor 150.

Next, monitoring device 101 refers to the countermeasure table (S170). More specifically, monitoring device 101 executes step S141 that follows, based on the countermeasure table stored in countermeasure table storage 160.

Next, monitoring device 101 determines whether to continue the charging/discharging of vehicle 21 (S141). For example, when step S141 is performed after step S160, monitoring device 101 determines whether to continue the charging/discharging of vehicle 21, based on the risk level of the detected attack and the remaining power information. In contrast, for example, when no attack is determined to be detected (No in S120), monitoring device 101 determines, in step S141, whether vehicle 21 has been charged/discharged by a predetermined amount of power (or more specifically, by a planned amount of power) based on the remaining power information, without determining, based on the risk level, whether to continue the charging/discharging of vehicle 21. Note that even when it is determined to be “No” in step S120, only step S160 may be performed among steps S130, S160, and S170. Then, after step S160, step S141 may be performed.

When monitoring device 101 determines to continue the charging/discharging of vehicle 21 (Yes in S141), monitoring device 101 returns to step S120 and continues performing the detection process.

In contrast, when monitoring device 101 determines not to continue the charging/discharging of vehicle 21 (No in S141), monitoring device 100 causes the charging/discharging of vehicle 21 to end (S150).

### [Advantageous Effects Etc.]

As described thus far, monitoring device 101 determines whether to allow the communication with charge-discharge stand 30, based on the risk level of the attack and the remaining power of battery 210. For example, even when the risk level is low, monitoring device 101 terminates the communication when battery 210 is charged to a predetermined value (50% capacity in the above example) or greater. Furthermore, even when the risk level is low, monitoring device 101 terminates the communication when battery 210 discharges to less than the predetermined value. Even when the risk level is low, the attack may have infiltrated into vehicle 21 without being detected. For this reason, monitoring device 101 permits only a minimal amount of charging/discharging.

In this way, the minimal amount of charging/discharging is permitted even in the event of an attack. However, when the risk level is high, the communication between vehicle 21 and charge-discharge stand 30 is blocked to prevent the attack from spreading.

### Variation

Note that the risk table and the countermeasure table may be freely defined. Note also that the risk level may be determined based on three or more categories instead of two.

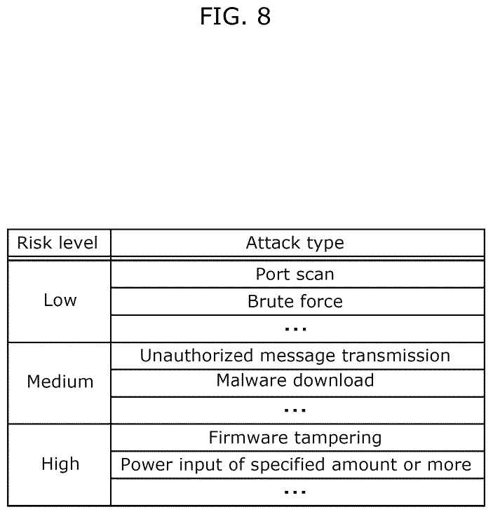

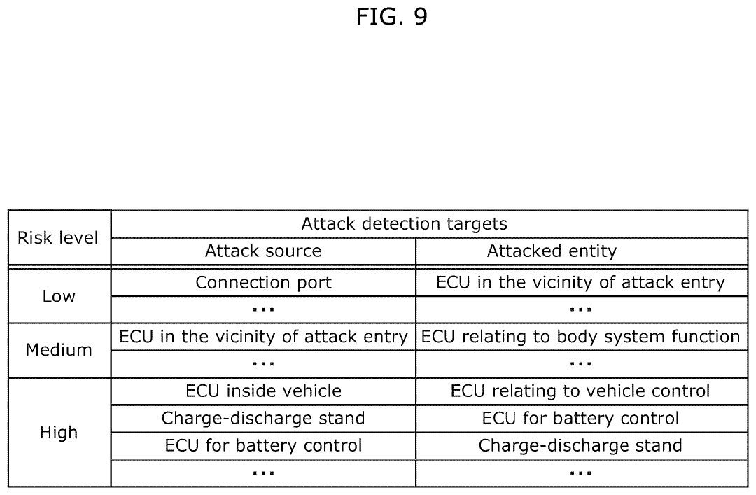

FIG. 8 and FIG. 9 are diagrams illustrating specific examples of the risk table.

FIG. 8 illustrates a third example of the risk table that shows a correspondence relationship between attack types and risk levels. More specifically, the risk table illustrated in the present example presents information associating each attack type with a corresponding risk level.

In the present example, the risk level is categorized as “low”, “medium”, or “high”. In the present example, the risk levels of “unauthorized message transmission” and “malware download” are categorized as “medium”. For example, when the type of the attack detected by attack detector 110 is “unauthorized message transmission”, countermeasure determiner 121 determines the risk level of the detected attack to be “medium”.

FIG. 9 illustrates a fourth example of the risk table that shows a correspondence relationship between attack detection targets and risk levels. More specifically, the risk table illustrated in the present example presents information associating each attack detection target with a corresponding risk level.

In the present example, when the attack source is “ECU in the vicinity of attack entry” and the attacked entity is “ECU relating to body system function”, the risk level is categorized as “medium”. For example, when the attacked entity that is the target of the attack detected by attack detector 110 is “ECU relating to body system function” and the attack source of this attack is “ECU in the vicinity of attack entry”, countermeasure determiner 121 determines the risk level of the detected attack to be “medium”. Note that the body system function is a function that provides an occupant of the vehicle with convenience and/or comfort. Examples provided by this function include operations of windshield wipers, power windows, and light-emitting diode (LED) headlights.

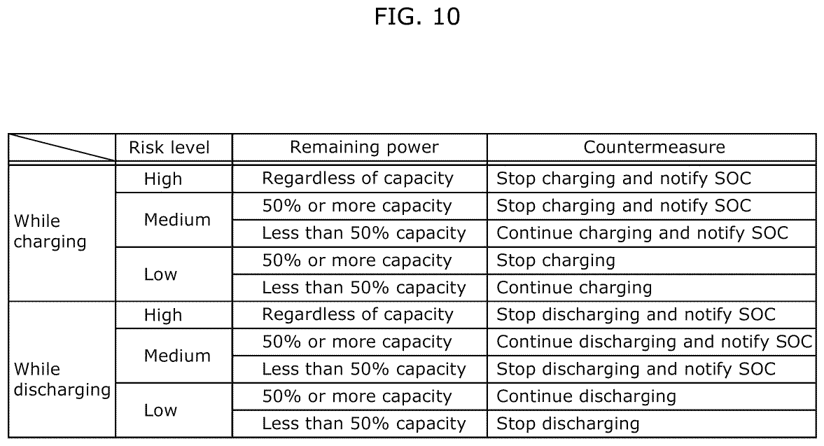

FIG. 10 is a diagram illustrating a specific example of the countermeasure table.

FIG. 10 illustrates a second example of the countermeasure table showing a correspondence relationship among risk levels, remaining power, and countermeasure methods.

In the present example, when the risk level of the detected attack is determined to be “high” while vehicle 21 is being charged, countermeasure determiner 121 performs a process of stopping the charging of vehicle 21 regardless of the remaining power amount of battery 210 and also outputs alert information to a computer used in an SOC (indicated as “notify SOC” in FIG. 10). For example, by outputting the alert information to vehicle controller 220, countermeasure determiner 121 causes the alert information to be transmitted via communication unit 230 to the computer used in the SOC. Countermeasure determiner 121 may transmit the alert information via communication unit 230 to the computer used in the SOC, without using vehicle controller 220.

In the present example, when the risk level of the detected attack is determined to be “medium” and the remaining power of battery 210 is 50% or more of the maximum capacity of battery 210 while vehicle 21 is being charged, countermeasure determiner 121 performs the process of stopping the charging of vehicle 21 and also outputs the alert information to the computer used in the SOC. In contrast, in the present example, when the risk level of the detected attack is determined to be “medium” and the remaining power of battery 210 is less than 50% of the maximum capacity of battery 210 while vehicle 21 is being charged, countermeasure determiner 121 causes the charging of vehicle 21 to continue and also outputs the alert information to the computer used in the SOC.

In the present example, when the risk level of the detected attack is determined to be “high” while vehicle 21 is discharging, countermeasure determiner 121 performs a process of stopping the discharging of vehicle 21 regardless of the remaining power of battery 210 and also outputs the alert information to the computer used in the SOC.

In the present example, when the risk level of the detected attack is determined to be “medium” and the remaining power of battery 210 is 50% or more of the maximum capacity of battery 210 while vehicle 21 is discharging, countermeasure determiner 121 causes the discharging of vehicle 21 to continue and also outputs the alert information to the computer used in the SOC. In contrast, in the present example, when the risk level of the detected attack is determined to be “medium” and the remaining power of battery 210 is less than 50% of the maximum capacity of battery 210 while vehicle 21 is discharging, countermeasure determiner 121 performs the process of stopping the discharging of vehicle 21 and also outputs the alert information to the computer used in the SOC.

In the present example as described, when the risk level of the detected attack is “medium”, whether to continue the charging/discharging is determined based on the remaining power of battery 210. Moreover, the alert information is also outputted to the computer used in the SOC, regardless of the remaining power of battery 210.

Note that the risk tables according to the present variation may be used by monitoring device 100 (or more specifically, by countermeasure determiner 120). For example, when the risk level is “high”, countermeasure determiner 120 causes the charging/discharging of vehicle 20 to stop and also outputs the alert information to the SOC. For example, when the risk level is “medium”, countermeasure determiner 120 causes the charging/discharging of vehicle 20 to continue and also outputs the alert information to the SOC. For example, when the risk level is “low”, countermeasure determiner 120 causes the charging/discharging of vehicle 20 to continue and does not output the alert information to the SOC.

### Representative Example

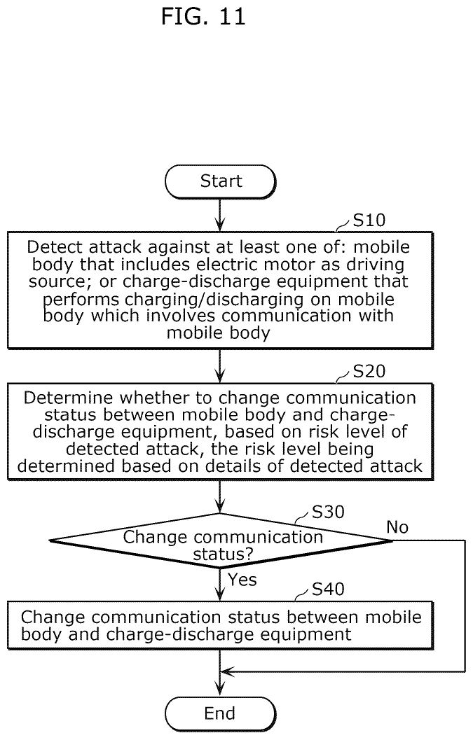

FIG. 11 is a flowchart illustrating a monitoring method according to one aspect of the present disclosure. For example, monitoring device 100 or monitoring device 101 includes a processor and a memory. The processor performs the following processes using the memory. These processes are described below as processes performed by monitoring device 100.

Monitoring device 100 first detects an attack against at least one of: a mobile body that includes electric motor 200 as a driving source; or charge-discharge equipment that performs charging/discharging on the mobile body which involves communication with the mobile body (S10).

Electric motor 200 is a motor that is included in the mobile body and driven by a battery included in the mobile body. Vehicles 20 and 21 described above are specific examples of the mobile body. Charge-discharge stand 30 described above is a specific example of the charge-discharge equipment.

Next, monitoring device 100 determines whether to change the communication status between the mobile body and the charge-discharge equipment, based on the risk level of the detected attack, the risk level being determined based on details of the detected attack (S20).

The details of the attack include the attack type described above and/or the attack detection targets described above, for example.

When monitoring device 100 determines to change the communication status between the mobile body and the charge-discharge equipment (Yes in S30), monitoring device 100 changes the communication status between the mobile body and the charge-discharge equipment (S40).

When monitoring device 100 determines to change the communication status between the mobile body and the charge-discharge equipment, monitoring device 100 causes the charging/discharging performed between the mobile body and the charge-discharge equipment to stop by terminating the communication established for the charging/discharging between the mobile body and the charge-discharge equipment, for example.

In contrast, for example, when monitoring device 100 determines not to change the communication status between the mobile body and the charge-discharge equipment (No in S30), monitoring device 100 does not change the communication status, that is, causes the communication and the charging/discharging performed between the mobile body and the charge-discharge equipment to continue and also continues performing the process of detecting an attack against at least one of the mobile body or the charge-discharge equipment.

### Summary

The following describes examples of techniques obtained from the disclosures of the present application and explains advantageous effects and the like obtained from the examples of the techniques.

Technique 1 is monitoring device 100 or 101 comprising: attack detector 110 that detects an attack against at least one of: a mobile body that includes electric motor 200 as a driving source; or charge-discharge equipment that performs at least one of charging or discharging on the mobile body, the at least one of charging or discharging involving communication with the mobile body; countermeasure determiner 120 or 121 that determines whether to change a communication status between the mobile body and the charge-discharge equipment, based on a risk level of the attack detected, the risk level being determined based on details of the attack detected; and communication controller 130 that changes the communication status between the mobile body and the charge-discharge equipment when the communication status between the mobile body and the charge-discharge equipment is determined to be changed.

For example, conventionally, charge-discharge equipment for charging a battery included in a vehicle and receiving discharge from the battery has been developed. For charging or discharging to be performed between the vehicle and the charge-discharge equipment, the vehicle and the charge-discharge equipment establish communication with each other.

When the vehicle or the charge-discharge equipment is attacked, a risk such as overcharging of the battery may occur. To respond to such a risk, the charging or discharging may be stopped by, for example, terminating (blocking) the communication between the vehicle and the charge-discharge equipment.

However, terminating the communication to stop the charging or discharging every time an attack is detected may be inefficient in terms of charging and discharging.

The present disclosure provides a monitoring device and so forth that are capable of reducing unnecessary termination of communication even when an attack is detected.

Therefore, monitoring device 100 or 101 is capable of causing the communication between the mobile body and the charge-discharge equipment to continue or end, depending on the risk level, that is, the details of the detected attack. Thus, monitoring device 100 or 101 described above is capable of causing the charging/discharging of the mobile body to continue or stop, depending on the details of the detected attack. This allows monitoring device 100 or 101 described above to reduce unnecessary termination of the communication even when an attack is detected, depending on the details of the detected attack.

Technique 2 is monitoring device 100 or 101 according to Technique 1, wherein countermeasure determiner 120 or 121: identifies a type of the attack detected; and determines the risk level of the attack detected, based on the type of the attack detected.

Examples of the attack type include port scan, unauthorized message transmission, and firmware tampering as described above. Although depending on the attack type, some attacks may pose a higher risk while others may pose a lower risk. In this view, monitoring device 100 or 101 described above can control the communication status, based on the risk level of the detected attack.

Technique 3 is monitoring device 100 or 101 according to Technique 1 or 2, wherein countermeasure determiner 120 or 121 identifies an attacked entity that has received the attack detected, and determines the risk level of the attack detected, based on the attacked entity.

Depending on the attacked entity, high-risk behavior may or may not occur. In this view, monitoring device 100 or 101 described above can control the communication status, based on whether high-risk behavior may occur.

Technique 4 is monitoring device 100 or 101 according to Technique 3, wherein countermeasure determiner 120 or 121 identifies an attack source of the attack detected, and determines the risk level of the attack detected, based on the attacked entity and the attack source.

Monitoring device 100 or 101 described above can control the communication status with another consideration for the attack source.

Technique 5 is monitoring device 101 according to any one of Techniques 1 to 4, further including: remaining power monitor 150 that monitors remaining power of a battery included in the mobile body.

Depending on the remaining power, it may be better to continue the charging/discharging or may not be a problem to immediately stop the charging/discharging. In this view, monitoring device 101 described above can further reduce unnecessary termination of the communication.

Technique 6 is monitoring device 101 according to Technique 5, wherein countermeasure determiner 121 determines whether to change the communication status between the mobile body and the charge-discharge equipment, based on the remaining power monitored by remaining power monitor 150 and the risk level of the attack detected.

Monitoring device 101 described above can further reduce unnecessary termination of communication with another consideration for the remaining power.

Technique 7 is monitoring device 100 or 101 according to any one of Techniques 1 to 6, wherein attack detector 110 detects the attack against the at least one of the mobile body or the charge-discharge equipment, based on attack information received from an external device about the attack against the at least one of the mobile body or the charge-discharge equipment.

For example, the external device is a computer capable of communicating with the mobile body and also capable of detecting attacks.

Monitoring device 100 or 101 described above can detect an attack, based on the information received from the external device.

Technique 8 is monitoring device 100 or 101 according to any one of Techniques 1 to 7, wherein countermeasure determiner 120 or 121 obtains, from an external device, risk level information indicating the risk level of the attack detected.

Monitoring device 100 or 101 described above can determine the risk level of the detected attack, based on the information received from the external device.

Technique 9 is monitoring device 100 or 101 according to any one of Techniques 1 to 8, wherein countermeasure determiner 120 or 121 determines the risk level of the attack detected, based on risk table information indicating a correspondence relationship between the details of the attack and the risk level.

Monitoring device 100 or 101 described above can easily determine the risk level of the detected attack, based on the risk table information.

Technique 10 is monitoring device 100 or 101 according to any one of Techniques 1 to 9, wherein when countermeasure determiner 120 or 121 determines, based on the risk level of the attack detected, to terminate the communication between the mobile body and the charge-discharge equipment, countermeasure determiner 120 or 121 outputs notification information indicating that the communication between the mobile body and the charge-discharge equipment is to be terminated.

The notification information is transmitted to the terminal used by the user of the mobile body, for example. Monitoring device 100 or 101 described above allows the user of the mobile body to immediately recognize that the communication between the mobile body and the charge-discharge equipment is to be terminated, that is, that the charging/discharging is to be stopped.

Technique 11 is a monitoring method including: detecting (S10) an attack against at least one of: a mobile body that includes electric motor 200 as a driving source; or charge-discharge equipment that performs at least one of charging or discharging on the mobile body, the at least one of charging or discharging involving communication with the mobile body; determining (S20) whether to change a communication status between the mobile body and the charge-discharge equipment, based on a risk level of the attack detected, the risk level being determined based on details of the attack detected; and changing (S40) the communication status between the mobile body and the charge-discharge equipment when the communication status between the mobile body and the charge-discharge equipment is determined to be changed (Yes in S30).

The above-described monitoring method produces the same advantageous effects as those produced by monitoring devices 100 and 101 according to technique 1.

The present disclosure may be implemented to a program that causes a computer to execute the above-described monitoring method, or a non-transitory computer-readable recording medium storing such a program.

### Other Embodiments

Although the embodiments have been described as above, the present disclosure is not limited to these embodiments.

For example, monitoring device 100 or 101 may determine whether charge-discharge stand 30 is independent of an infrastructure (that is, not connected to a network) like a home-use charge-discharge stand. For example, when charge-discharge stand 30 is independent of the infrastructure, monitoring device 100 or 101 may allow, regardless of whether to detect an attack, charge-discharge stand 30 to perform charging/discharging on vehicle 20 or 21 similarly to when no attack is detected. In contrast, for example, when charge-discharge stand 30 is not independent of the infrastructure, monitoring device 100 or 101 may perform the processes of the flowchart illustrated in FIG. 4, FIG. 7, or FIG. 11. For example, monitoring device 100 or 101 may obtain information indicating whether charge-discharge stand 30 is independent of the infrastructure, from charge-discharge stand 30, the terminal used by the user, or an external communication device, such as a server.

For example, the risk levels may be classified under categories such as “high”, “medium”, and “low”. Alternatively, the risk levels may be classified under numeric values such as “1”, “2”, and “3”.

For example, monitoring device 100 or 101 is mounted to the mobile body. However, monitoring device 100 or 101 may be disposed outside the mobile body when monitoring device 100 or 101 can communicate with the mobile body. For example, by communicating with the mobile body (with vehicle controller 220 included in vehicle 20 or 21, for example), monitoring device 100 or 101 may cause vehicle controller 220 to change the communication status between the mobile body and the charge-discharge equipment.

For example, the mobile body is a vehicle. However, the mobile body may be any mobile body, such as an automobile, a motorcycle, or a mobile robot that is driven using a battery as a power source.

The charge-discharge equipment may have both the function of charging the mobile body and the function of receiving discharge from the mobile body, or may have only one of these functions.

For example, it is possible in each of the above-described embodiments that the process performed by a certain processing unit may be performed by another processing unit, that an order of a plurality of processes is changed, or that a plurality of processes are performed in parallel.

Each of the constituent elements in each of the above-described embodiments may be realized by executing a software program suitable for the element. Each of the constituent elements may be realized by means of a program executing unit, such as a Central Processing Unit (CPU) or a processor, reading and executing the software program recorded on a recording medium such as a hard disk or semiconductor memory.

Each of the constituent elements may be implemented to a hardware. The constituent elements may be implemented to circuits (or integrated circuits). These circuits may form a single circuit as a whole, or serve as separate circuits. Each circuit may be may be a general-purpose circuit or a dedicated circuit.

These general and specific aspects of the present disclosure may be implemented to a device, a system, a method, an integrated circuit, a computer program, or a non-transitory computer-readable recording medium such as a Compact Disc-Read Only Memory (CD-ROM), or may be any combination of them.

In addition, the present disclosure may include embodiments obtained by making various modifications on the above-described embodiments which those skilled in the art will arrive at, or embodiments obtained by selectively combining the elements and functions disclosed in the above-described embodiments, without materially departing from the scope of the present disclosure.

### Further Information About Technical Background to This Application

The disclosure of the following patent application including specification, drawings, and claims are incorporated herein by reference in their entirety: Japanese Patent Application No. 2024-204702 filed on Nov. 25, 2024.

### Industrial Applicability

The present disclosure is useful to a device that performs a process in response to an attack against a vehicle or a charge-discharge equipment.

1. A monitoring device comprising:
an attack detection circuit that detects an attack against at least one of: a mobile body that includes an electric motor as a driving source; or charge-discharge equipment that performs at least one of charging or discharging on the mobile body, the at least one of charging or discharging involving communication with the mobile body;
a countermeasure determination circuit that determines whether to change a communication status between the mobile body and the charge-discharge equipment, based on a risk level of the attack detected, the risk level being determined based on details of the attack detected; and
a communication control circuit that changes the communication status between the mobile body and the charge-discharge equipment when the communication status between the mobile body and the charge-discharge equipment is determined to be changed.

2. The monitoring device according to claim 1, wherein
the countermeasure determination circuit:
identifies a type of the attack detected; and
determines the risk level of the attack detected, based on the type of the attack detected.

3. The monitoring device according to claim 1, wherein
the countermeasure determination circuit
identifies an attacked entity that has received the attack detected, and
determines the risk level of the attack detected, based on the attacked entity.

4. The monitoring device according to claim 3, wherein
the countermeasure determination circuit
identifies an attack source of the attack detected, and
determines the risk level of the attack detected, based on the attacked entity and the attack source.

5. The monitoring device according to claim 1, further comprising:
a remaining power monitoring circuit that monitors remaining power of a battery included in the mobile body.

6. The monitoring device according to claim 5, wherein
the countermeasure determination circuit determines whether to change the communication status between the mobile body and the charge-discharge equipment, based on the remaining power monitored by the remaining power monitoring circuit and the risk level of the attack detected.

7. The monitoring device according to claim 1, wherein
the attack detection circuit detects the attack against the at least one of the mobile body or the charge-discharge equipment, based on attack information received from an external device about the attack against the at least one of the mobile body or the charge-discharge equipment.

8. The monitoring device according to claim 1, wherein
the countermeasure determination circuit obtains, from an external device, risk level information indicating the risk level of the attack detected.

9. The monitoring device according to claim 1, wherein
the countermeasure determination circuit determines the risk level of the attack detected, based on risk table information indicating a correspondence relationship between the details of the attack and the risk level.

10. The monitoring device according to claim 1, wherein
when the countermeasure determination circuit determines, based on the risk level of the attack detected, to terminate the communication between the mobile body and the charge-discharge equipment, the countermeasure determination circuit outputs notification information indicating that the communication between the mobile body and the charge-discharge equipment is to be terminated.

11. A monitoring method comprising:
detecting an attack against at least one of: a mobile body that includes an electric motor as a driving source; or charge-discharge equipment that performs at least one of charging or discharging on the mobile body, the at least one of charging or discharging involving communication with the mobile body;
determining whether to change a communication status between the mobile body and the charge-discharge equipment, based on a risk level of the attack detected, the risk level being determined based on details of the attack detected; and
changing the communication status between the mobile body and the charge-discharge equipment when the communication status between the mobile body and the charge-discharge equipment is determined to be changed.
